(19) United States
(12) Patent Application Publication
(10) Pub. No.: US 2017/0245662 A1
(43) Pub. Date: Aug. 31, 2017

(54) VEHICLE DISPLAY SYSTEM AND METHOD

(71) Applicant: Global Sourcing & Support Services, LLC, Cincinnati, OH (US)

(72) Inventors: John Schlegel, Cincinnati, OH (US); Tom Wendt, Cincinnati, OH (US)

(21) Appl. No.: 15/056,206

(22) Filed: Feb. 29, 2016

(51) Int. Cl. A47F 7/00; G09F 23/00; E04F 11/00

(52) U.S. Cl. CPC A47F 7/00; E04F 11/002; G09F 23/00; E04F 2011/007; G09F 2007/1852

(57) ABSTRACT

A vehicle support and display apparatus includes vertical support posts. Transverse frame members are releasably coupled to respective vertical support posts. Lengthwise frame members are releasably coupled to the vertical support posts. Vehicle support members support the weight of the vehicle and transfer the weight to the ground via the frame members and the vertical support posts.

### TECHNICAL FIELD

The present invention generally relates to support and display apparatus and, more specifically, to support and display apparatus including ramps and platforms for exhibiting all types of vehicles.

### BACKGROUND

Various types of support and display units are used for vehicles such as cars, trucks, all terrain vehicles, and motorcycles, farm equipment or the like at facilities including dealerships, auto shows and auctions, and rental agencies. These vehicle support and display units allow a vehicle to be raised off the ground for better visibility. The support and display units may, for example, comprise metallic support structures capable of supporting vehicle weights, such as up to 6,000 pounds or more. These structures are generally difficult to assemble and/or may comprise permanent structures formed from concrete. That may not be a concern for those who desire a more or less permanent structure. However, various users may desire a more portable vehicle support structure that is nevertheless capable of safely supporting a wide variety of large or small vehicles.

More specifically, various facilities, including car dealerships, auto shows, auctions, car rental agencies, and other entities, have desired display systems that may be quickly constructed and deconstructed, and easily stored and shipped. To date, such a vehicle support and display apparatus or system has not been available. Therefore, a vehicle support and display apparatus or system is desired that addresses these and other issues, and can also safely support a wide range of vehicle weights.

### SUMMARY

In one illustrative embodiment, a vehicle support and display apparatus is provided and includes a first plurality of vertical support posts and a second plurality of vertical support posts spaced from the first plurality of vertical support posts. Lower transverse frame members are releasably coupled to respective lower portions of the first and second pluralities of vertical support posts. Upper transverse frame members are releasably coupled to respective upper portions of the first and second pluralities of vertical support posts. Lower lengthwise frame members are releasably coupled to respective lower portions of the first and second pluralities of vertical support posts. Upper lengthwise frame members are releasably coupled to respective upper portions of the first and second pluralities of vertical support posts. The lower and upper transverse frame members extend in a transverse or cross-wise direction relative to the lower and upper lengthwise frame members. Vehicle support members are releasably coupled between respective ones of the upper transverse frame members for supporting the weight of the vehicle.

Further aspects and embodiments are provided as options for the invention depending on desires of the user and/or other requirements such as necessary loading and vehicle size. For example, corner support brackets are coupled between the respective vertical support posts and the upper transverse frame members, and between the respective vertical support posts and the upper lengthwise frame members. The corner support brackets may be releasably coupled to the respective vertical support posts, the upper transverse frame members and the upper lengthwise frame members. A plurality of vehicle support panels are placed on top of the vehicle support members for spreading vehicle load when a vehicle is placed on the vehicle support panels. More specifically, in this option, the vehicle support panels further comprise first and second tread deck panels, and the vehicle support members further comprise a first vehicle support member spaced from and parallel to a first one of the upper lengthwise frame members and a second vehicle support member spaced from and parallel to a second one of the upper lengthwise frame members. The first tread deck panel is supported on the first vehicle support member and the first one of the upper lengthwise frame members and the second tread deck panel is supported on the second vehicle support member and the second one of the upper lengthwise frame members. In another example or embodiment of the invention, the vehicle support members are oriented horizontally and form a vehicle platform. In another example, the vehicle support members are oriented on an incline and form a vehicle ramp.

As additional features, a graphics panel may be releasably coupled to at least one of the upper lengthwise frame members, upper transverse frame members lower transverse frame members, upper transverse frame members, or vertical support posts. For example, the graphics panel may be magnetically coupled to at least one of the upper lengthwise frame members, upper transverse frame members, lower transverse frame members, upper transverse frame members, or vertical support posts. A lighting unit may be coupled to at least one of the upper lengthwise frame members, upper transverse frame members, lower lengthwise frame members, lower transverse frame members, or vertical support posts. These options allow for various graphics, such as promotional advertising, to be integrated on the vehicle support and display apparatus, and for the vehicle and/or the graphics to be illuminated in the evening and at night.

The invention also generally provides a method of assembling a vehicle support and display apparatus. The method includes placing a first plurality of vertical support posts in spaced apart relation and placing a second plurality of vertical support posts spaced from the first plurality of vertical support posts. Lower transverse frame members are releasably coupled to respective lower portions of the first and second pluralities of vertical support posts. Upper transverse frame members are releasably coupled to respective upper portions of the first and second pluralities of vertical support posts. Lower lengthwise frame members are releasably coupled to respective lower portions of the first and second pluralities of vertical support posts. Upper lengthwise frame members are releasably coupled to respective upper portions of the first and second pluralities of vertical support posts. The lower and upper transverse frame members extend in a transverse or cross-wise direction relative to the lower and upper lengthwise frame members. Vehicle support members are releasably coupled between respective ones of the upper transverse frame members for supporting the weight of the vehicle.

The method may include additional steps and/or aspects. In these regards, corner support brackets are coupled between the respective vertical support posts and the upper transverse frame members, and between the respective vertical support posts and the upper lengthwise frame members. The method can further comprise releasably coupling the corner support brackets to the vertical support posts, and respectively to the upper transverse frame members and the upper lengthwise frame members. In another aspect, the method can include placing vehicle support panels on top of the vehicle support members for spreading vehicle load when a vehicle is placed on the vehicle support panels. More specifically, for example, the vehicle support panels may further comprise first and second tread deck panels, and the vehicle support members may further comprise a first vehicle support member spaced from and parallel to a first one of the upper lengthwise frame members and a second vehicle support member spaced from and parallel to a second one of the upper lengthwise frame members. The method then may further comprise supporting the first tread deck panel on the first vehicle support member and the first one of the upper lengthwise frame members, and supporting the second tread deck panel on the second vehicle support member and the second one of the upper lengthwise frame members.

The method may further comprise orienting the plurality of vehicle support members horizontally to form a vehicle platform. As another option, the method can include orienting the plurality of vehicle support members on an incline to form a vehicle ramp. These aspects could also be combined such that the support and display apparatus has both a ramp section and a platform section. For a longer platform or ramp, multiple platform or ramp sections may be constructed in a lengthwise manner, such as for supporting longer vehicles (e.g., trucks). This may include adding further vertical support posts, transverse frame members and lengthwise frame members as well as any of the other connecting and fastening parts discussed herein. As another additional aspect, the method may include releasably coupling a graphics panel to at least one of the upper lengthwise frame members, upper transverse frame members, lower lengthwise frame members, lower transverse frame members, or vertical support posts. Various releasable couplings may be used in this regard, with one option being a magnetic coupling between a magnetic strip on the graphics panel and steel frame members and/or posts associated with the apparatus. The method may further include coupling a lighting unit to at least one of the upper lengthwise frame members, upper transverse frame members, lower lengthwise frame members, lower transverse frame members, or vertical support posts. The lighting may be used to illuminate the graphics and/or the vehicle, especially in the evening and at night.

Various additional aspects and features of the invention will become more readily apparent to those of ordinary skill in the art upon review of the following detailed description of the illustrative embodiments.

### BRIEF DESCRIPTION OF THE FIGURES

FIG. 1 is a perspective view illustrating both an elevated platform holding a vehicle relatively horizontal, as well as ramp holding a vehicle at an inclined angle.

FIG. 2 is a perspective view of the first embodiment, i.e., the vehicle display platform of FIG. 1, but eliminating the graphics panels and the vehicle for clarity.

FIG. 3A is a perspective view illustrating the vehicle platform of FIG. 2, in a deconstructed or disassembled state.

FIG. 3B is a perspective view illustrating an enlarged corner section of the vehicle platform.

FIG. 3C is a perspective view similar to FIG. 3B, but showing the assembled state of two frame members to one of the vertical support posts as well as the attachment of two corner support brackets to the vertical support post.

FIG. 3D is a perspective view similar to FIG. 3C, but illustrating the further attachment of the corner support brackets to the vertical support post and upper frame members attached to the corner support brackets.

FIG. 3E is a perspective view showing the continued assembly of the vehicle platform including further corner support brackets, and further frame members as well as the initial attachment of a lengthwise extending vehicle support member.

FIG. 3F is a perspective view similar to FIG. 3E, but illustrating further vehicle support members affixed between upper transverse frame members and extending in lengthwise directions.

FIG. 3G is a perspective view similar to FIG. 3F, but illustrating the further attachment of vehicle support panels, including outer tread deck panels and inner filler panels, on top of the vehicle support members.

FIG. 3H is a perspective view similar to FIG. 3G, but illustrating the attachment of graphics panels, including indicia such as advertisements.

FIGS. 4A-4D are enlarged, partially fragmented views, showing additional construction and assembly details of the platform shown in FIGS. 3A-3G.

FIGS. 5A-5G are perspective views similar to FIGS. 3A-3G, but illustrating the construction and assembled condition of a second embodiment of the apparatus, i.e., a vehicle display ramp.

FIG. 6 is a perspective view showing an enlarged illustration of a vehicle entry plate at the lower end of the vehicle ramp structure.

### DETAILED DESCRIPTION

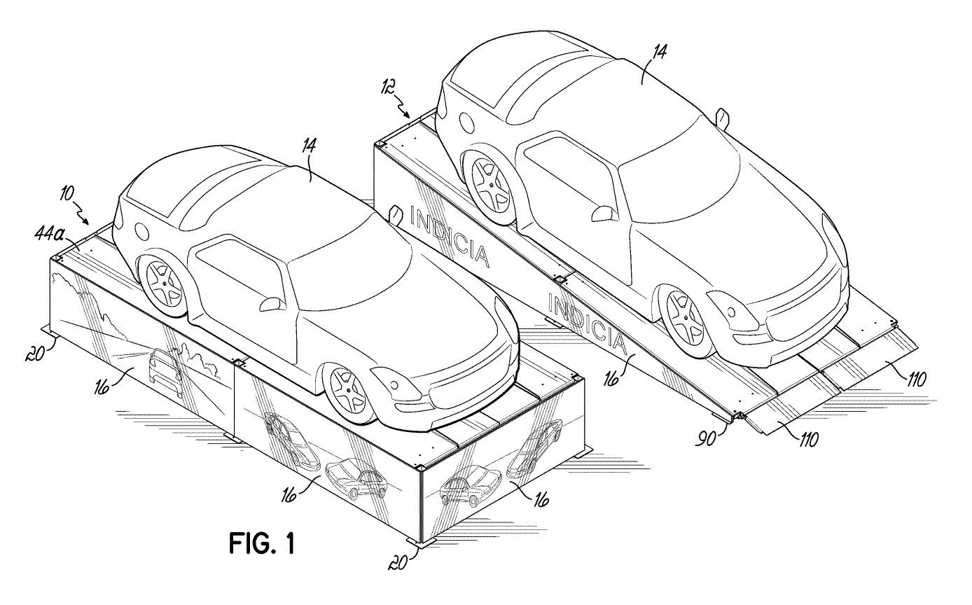

FIG. 1 illustrates first and second embodiments of vehicle support and display apparatus 10, 12. In one embodiment, the apparatus is configured as a raised horizontal platform 10, while in the other embodiment the apparatus is configured as an inclined support or ramp 12. In either case, a vehicle 14 on the apparatus is elevated for better visibility and exhibition. It will be appreciated that the apparatus of these two embodiments may also be combined such that the support and display apparatus has both a horizontal platform section 10 and an inclined ramp section 12. These apparatus further illustrate the use of graphics panels 16 which may be releasably coupled to the underlying frame and/or post components (not shown in FIG. 1) of the apparatus, as will be further discussed below.

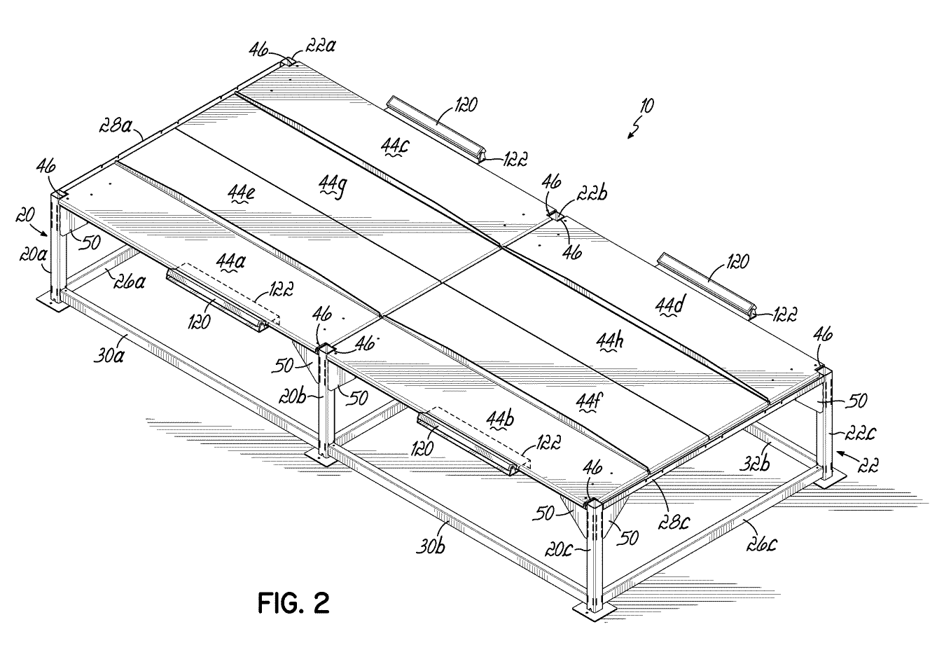

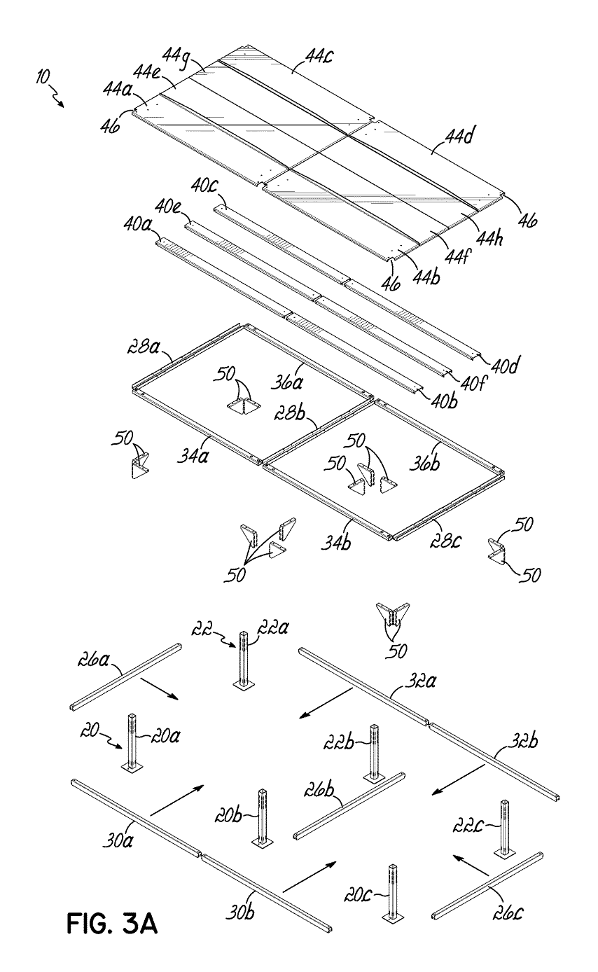

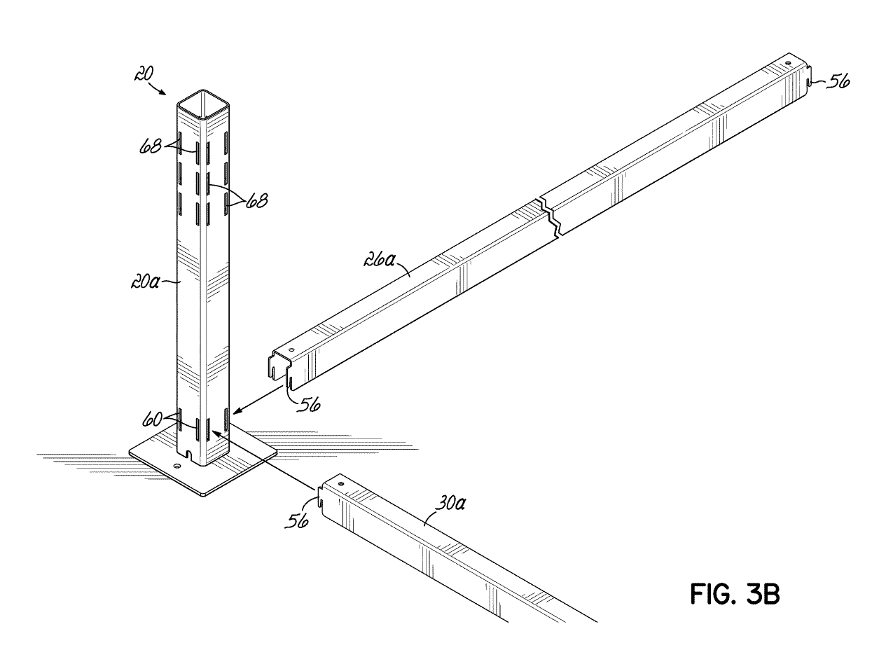

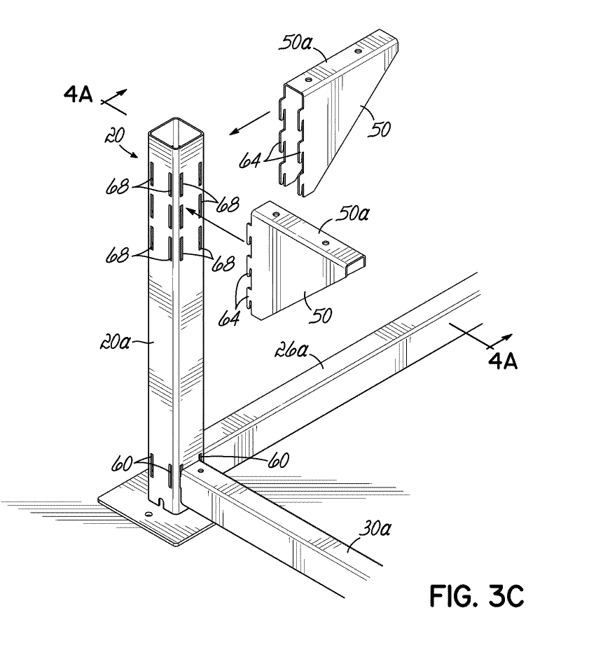

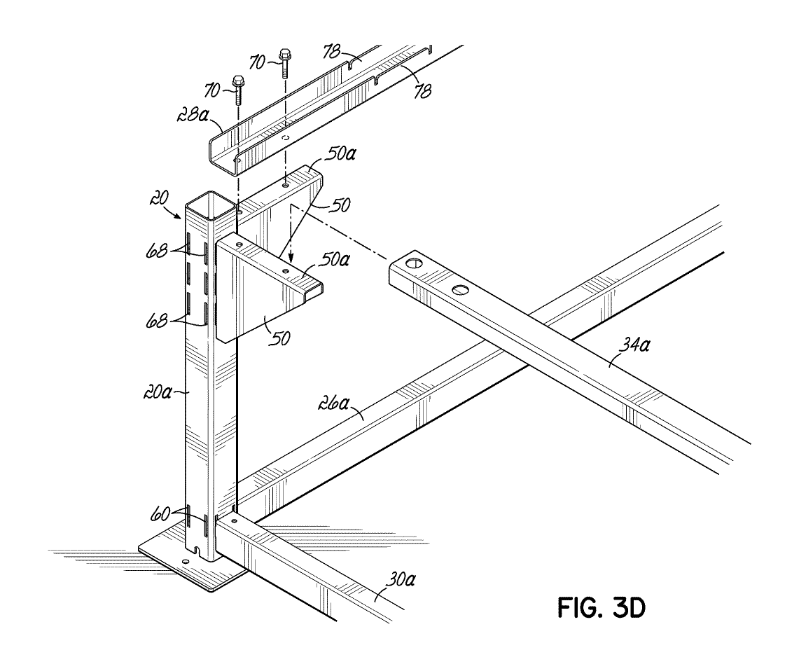

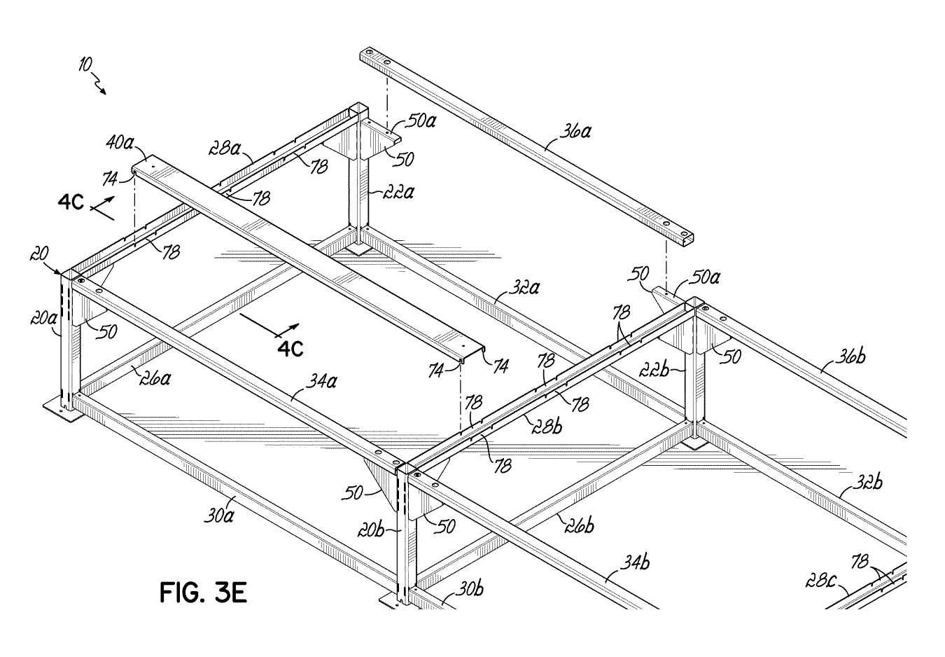

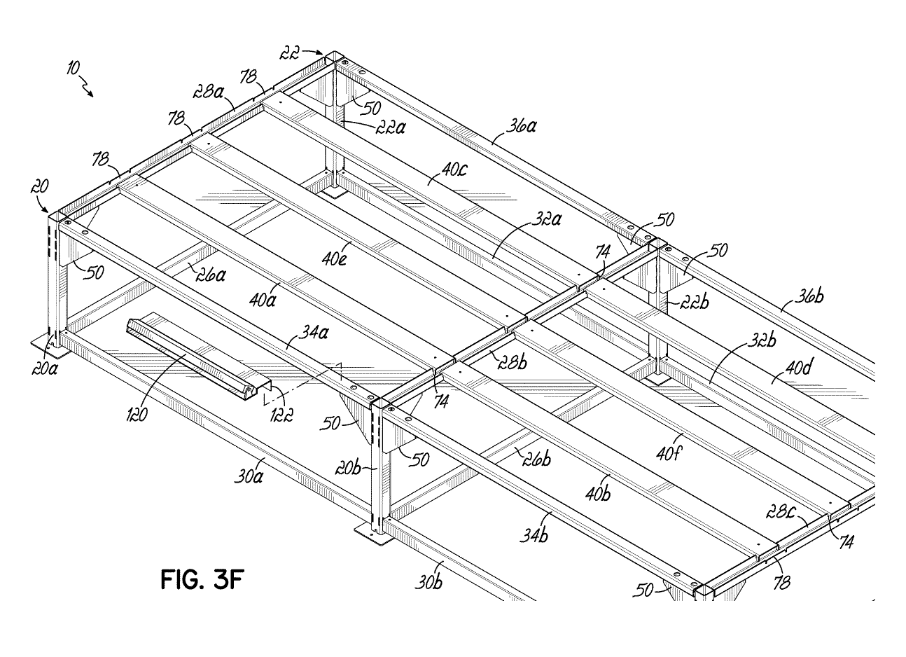

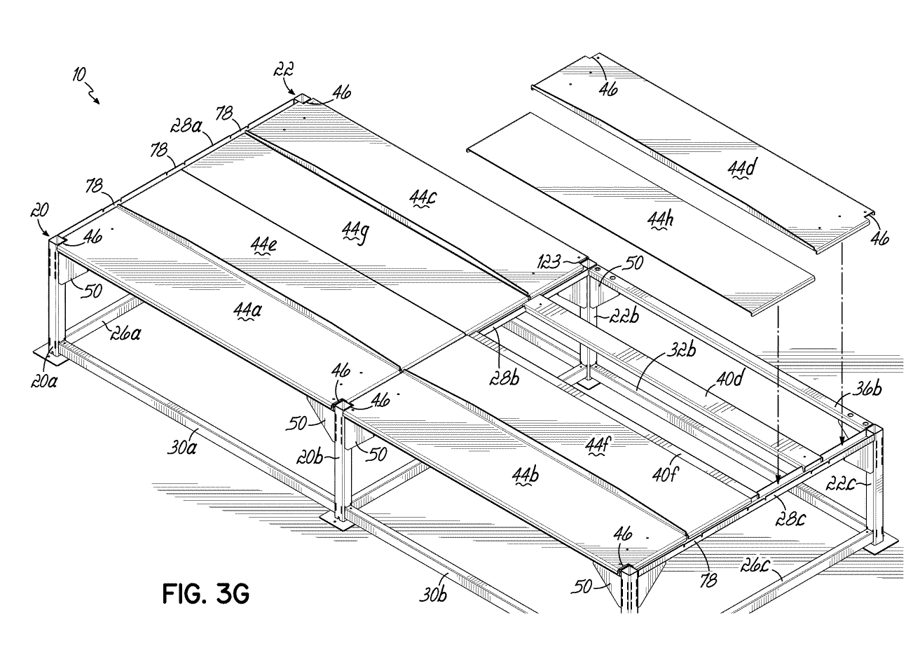

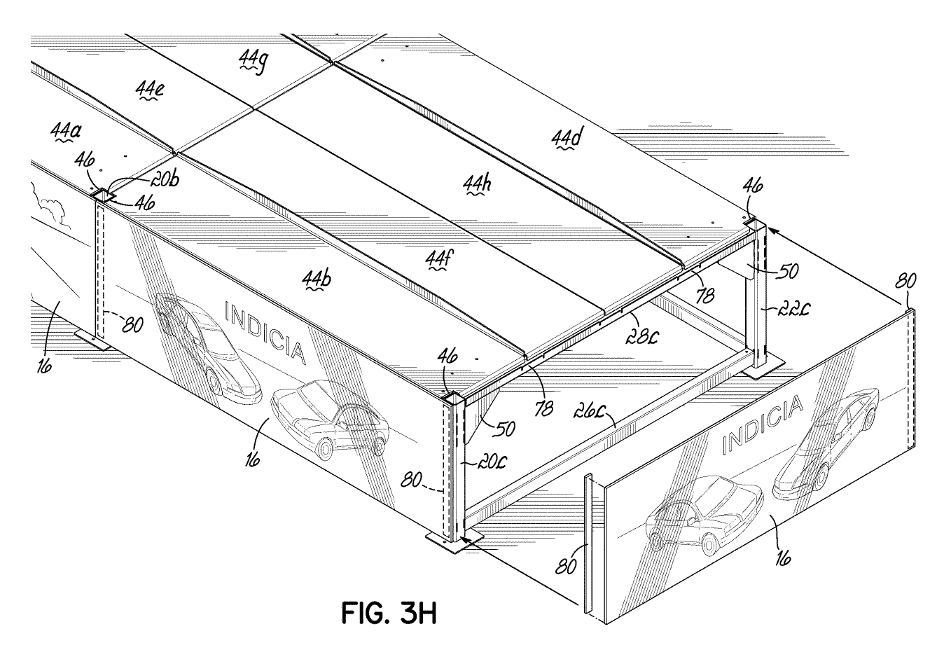

Referring to FIGS. 2 and 3A, the platform 10 is shown with the vehicle and graphics panels 16 (FIG. 1) removed for clarify. FIG. 2 illustrates the platform 10 in assembled form, while FIG. 3A illustrates the platform 10 in disassembled, exploded form. Specifically, the platform 10 includes a first plurality 20 of vertical support posts 20a, 20b, 20c, and a second plurality 22 of vertical support posts 22a, 22b, 22c spaced from the first plurality 20 of vertical support posts 20a, 20b, 20c. Lower transverse frame members 26a, 26b, 26c are releasably coupled to respective lower portions of the first and second pluralities 20, 22 of vertical support posts 20a-c, 22a-c. Upper transverse frame members 28a, 28b, 28c are releasably coupled to respective upper portions of the first and second pluralities 20, 22 of vertical support posts 20a-c, 22a-c. In this embodiment, for example, there are three vertical support posts 20a-c in the first plurality 20, and three vertical support posts 22a-c in the second plurality 22, and these are spaced apart in a transverse direction. However, for a shorter platform 10, only two pairs of vertical support posts 20a, 20b and 22a, 22b may be needed, and for longer platforms 10 additional vertical support posts (not shown) can be used. In either case, the construction between the support posts 20a-c, 22a-c may be as shown and described herein. Lower lengthwise frame members 30a, b and 32a, b are releasably coupled to respective lower portions of the first and second pluralities 20, 22 of vertical support posts 20a-c, 22a-c, and upper lengthwise frame members 34a, b and 36a, b are releasably coupled to respective upper portions of the first and second pluralities 20, 22 of vertical support posts 20a-c, 22a-c. As shown, there are four lower lengthwise frame members 30a, b and 32a, b and four upper lengthwise frame members 34a, b and 36a, b. The lower and upper transverse frame members 26a, 26b, 26c, 28a, 28b, 28c extend in a transverse direction relative to the lower and upper lengthwise frame members 30a, 30b, 32a, 32b, 34a, 34b, 36a, 36b. The terms “transverse” and “lengthwise” generally refer to directions associated with the vehicle 14 (FIG. 1), as per one exemplary intended use of the apparatus 10, 12. The length of the vehicle 14 will typically extend in the same direction as the lengthwise frame members 30a, 30b, 32a, 32b, 34a, 34b, 36a, 36b, while the transverse frame members 26a, 26b, 26c, 28a, 28b, 28c extend crosswise or transverse to the length of the vehicle 14. It will be appreciated that in various embodiments, there will be no need for the apparatus 10, 12 to have a length greater than its width. For example, the apparatus 10, 12 may be constructed with a square shape in which the lengthwise and transverse dimensions are approximately equal. A smaller square embodiment may be suitable for smaller vehicles (not shown) such as motorcycles and all terrain vehicles.

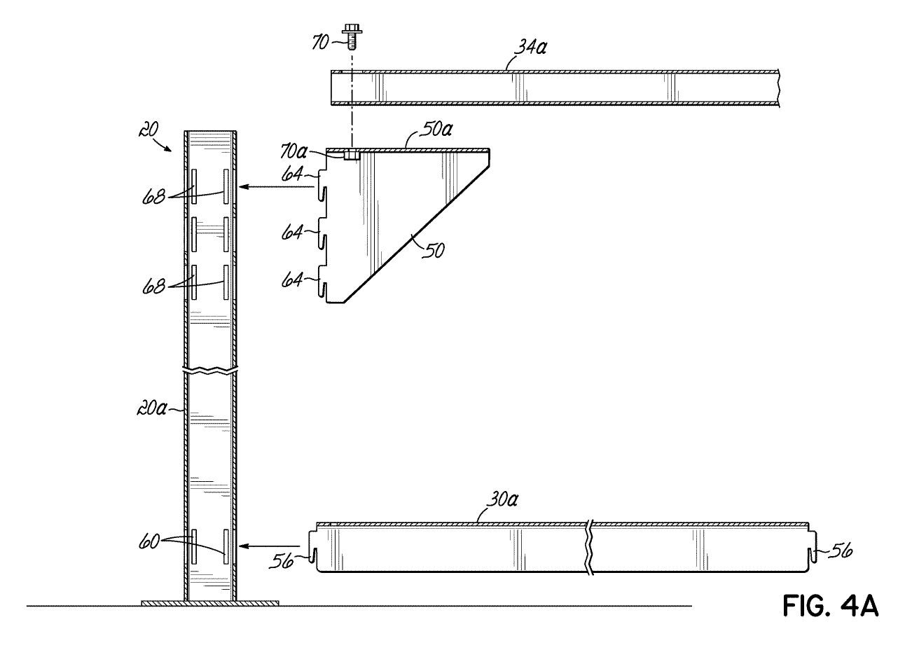

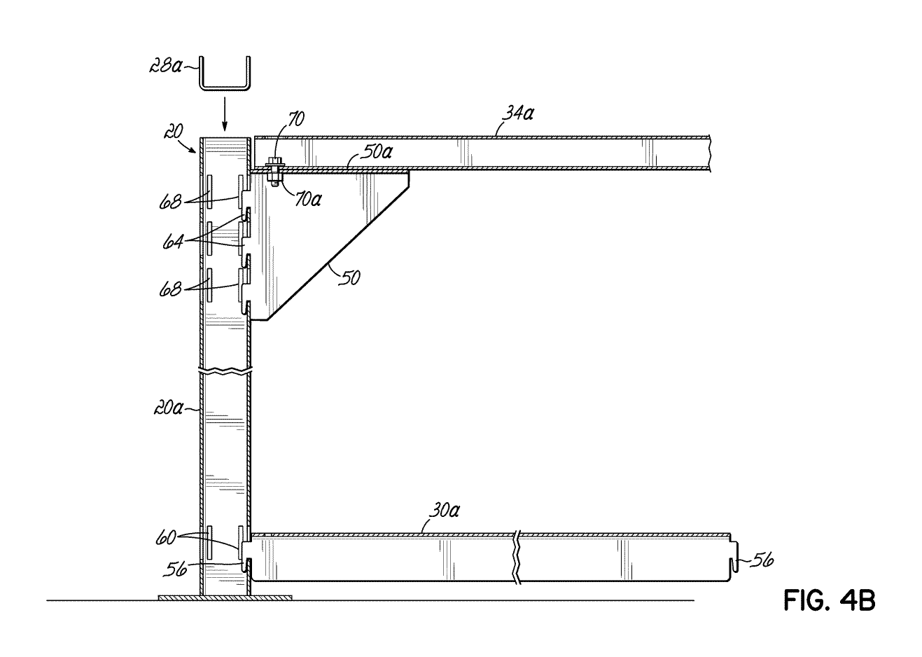

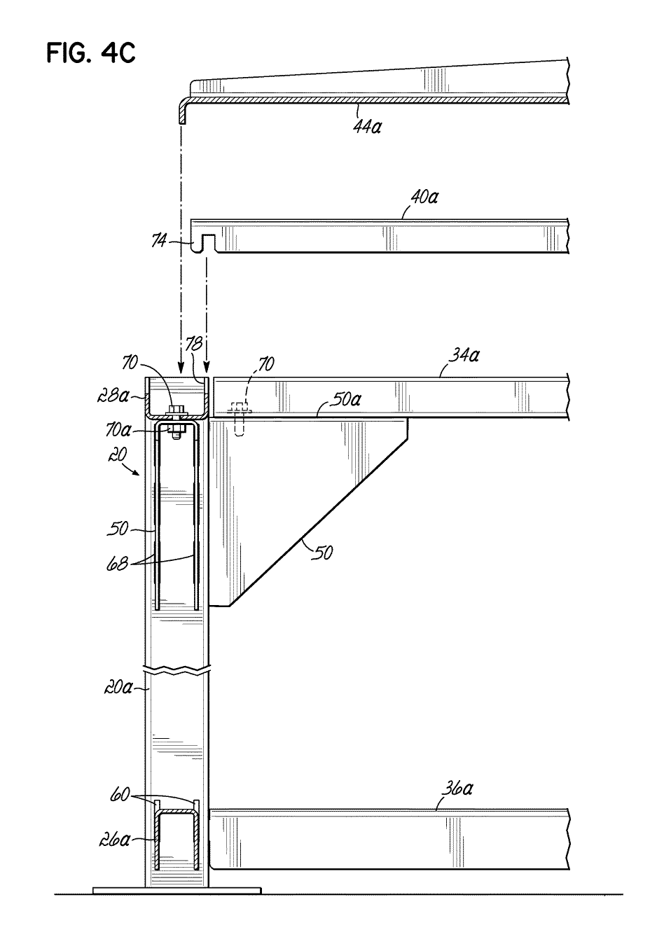

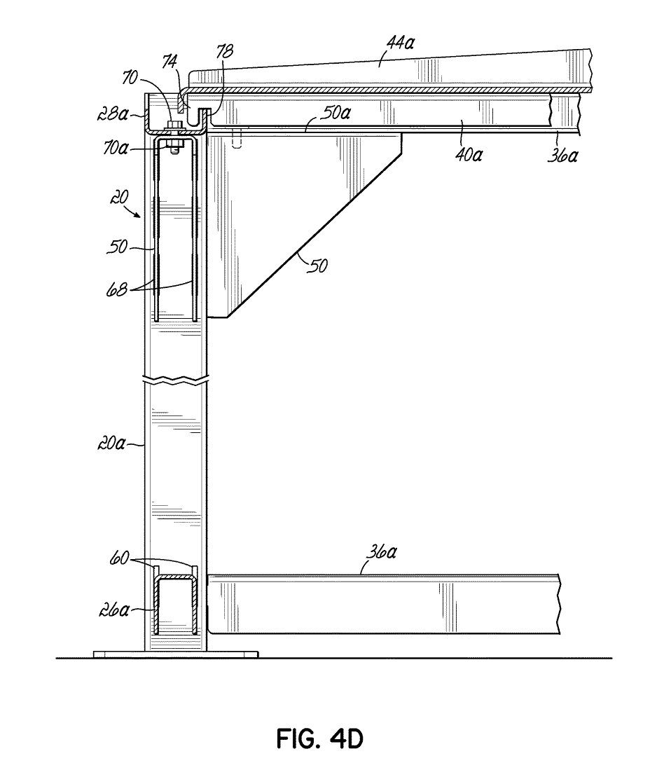

Vehicle support members 40a-f are releasably coupled so as to be generally located between respective ones of the upper transverse frame members 28a, 28b, 28c for supporting the weight of the vehicle 14 (FIG. 1). As shown, there are six vehicle support members 40a-f that are fairly widely spaced apart and extend lengthwise. A plurality of vehicle support panels 44a-h are placed on top of the vehicle support members 40a-f. In certain embodiments, however, it will be appreciated that the vehicle support members 40a-f may fully support the vehicle 14 (FIG. 1) and the panels 44a-h may be eliminated. In such an embodiment, the vehicle support members 40a-f would be made with widthwise dimensions large enough to accept the vehicle, and/or additional vehicle support members (not shown) would be added to fill in the spaces between the vehicle support members 40a-f shown in FIG. 3A. In other embodiments the vehicle support members 40a-f could extend in a transverse direction although they would still be generally located between upper transverse frame members 28a-c even though they could be connected to upper lengthwise frame members 34a, b and 36a, b. The platform 10 further includes corner support brackets 50 coupled between the respective first and second pluralities 20, 22 of vertical support posts 20a-c, 22a-c and the upper transverse frame members 28a-c, and between the respective first and second pluralities 20, 22 of vertical support posts 20a-c, 22a-c and the upper lengthwise frame members 34a, b and 36a, b. These corner support brackets 50 provide further weight bearing support and load spreading capability between the transverse frame members 26a-c, 28a-c and the vertical posts 20a-c, 22a-c, and between the lengthwise frame members 30a-b, 32a-b, 34a-band 36a-b and the vertical posts 20a-b, 22a-b. In certain embodiments, these corner support brackets 50 may not be necessary, such as in embodiments of the apparatus 10, 12 that are not designed to carry the high load of a car or truck but instead carry smaller loads such as motorcycles and all terrain vehicles. In this embodiment, the corner support brackets 50 may be releasably coupled to the vertical support posts 20a-b, 22a-b and also releasably coupled to either a transverse frame member 26a-c, 28a-c or a lengthwise frame member 30a-b, 32a-b, 34a-b and 36a-b to provide further modularity and capability for easy assembly, disassembly, shipping and storage. See FIGS. 4A-4D, and further discussion below.

Referring again to FIG. 3A, the plurality of vehicle support panels 44a-h further comprise first and second tread deck panels 44a, b and 44c, d positioned at each opposite, outer portion of the platform and four filler panels 44e-h positioned at a central area of the platform 10. The tread deck panels 44a-d are configured and positioned to accept and support the wheels of a vehicle 14 (FIG. 1). The tread deck panels 44a-d have cut-outs 46 for receiving upper ends of the support posts 20a-c and 22a-c. The plurality of vehicle support members 40a-f further comprise first vehicle support members 40a, 40b spaced from and parallel to first ones 34a, 34b of the upper lengthwise frame members and second vehicle support members 40c, 40d spaced from and parallel to second ones 36a, 36b of the upper lengthwise frame members. The first tread deck panels 44a, 44b are supported on the first vehicle support members 40a, 40b and the first ones 34a, 34b of the upper lengthwise frame members and the second tread deck panels 44c, 44d are supported on the second vehicle support members 40c, 40d and the second ones 36a, 36b of the upper lengthwise frame members. As shown in this embodiment, the vertical support posts 20a-c, 22a-c have equal heights and the vehicle support members 40a-f are oriented horizontally to form the vehicle platform 10 which is configured to hold and display a vehicle 14 such as a car, truck or the like in a horizontal orientation (FIG. 1). It will be appreciated that, in this embodiment, various vehicle support members such as 40e, 40f and various panels such as 44e-h may not actually support vehicle weight.

Referring to FIG. 3B, the lower transverse frame members 26a-c and the lower lengthwise frame members 30a, b and 32a, b are formed as U-shaped steel beams having integral hook-shaped elements 56 at opposite ends. The hook-shaped elements 56 register in respective slots 60 of each vertical post 20a-c, 22a-c. The vertical posts 20a-c, 22a-c are formed with these respective slots 60 on each of four sides of a hollow square steel tube such that the orientation of the vertical posts 20a-c, 22a-c may be made in any of four directions and still be releasably engageable with the frame members 26a-c, 30a, 30b and 32a, b as more generally shown in FIG. 2.

As shown in FIGS. 3C and 4A-4D, the corner brackets 50 likewise have hook-shaped elements 64 along one vertical side and these register within slots 68 at the upper portion of each vertical post 20a-c, 22a-c. These corner brackets 50 are formed from steel and also have a U-shaped cross-sectional configuration with a flat top surface 50a for accepting the upper transverse frame members 28a-c and upper lengthwise frame members 34a, b and 36a, b. The upper surfaces 50a of the corner brackets 50 form a 90 degree angle with the vertical posts 20a-c, 22a-c. As shown in FIG. 3D, each corner bracket 50 is identically designed and releasably couples with an upper transverse frame member 28a-c or an upper lengthwise frame member 34a, b and 36a, b using fasteners, such as bolts 70. The upper transverse frame members 28a-c are U-shaped channels or beams and are oriented such that the U-shaped channel opens upwardly, while the upper lengthwise frame members 34a, b and 36a, b are square tubular steel beams. These upper transverse and lengthwise frame members 28a-c, 34a, b and 36a, b are secured to the respective corner brackets 50 using threaded fasteners, e.g., bolts 70, as mentioned, that engage nuts 70a (FIGS. 4A-4D) welded inside the corner brackets 50. This process is repeated between each of the vertical posts 20a-c, 22a-c as shown in FIG. 3E, until all of the corner brackets 50 and all of the upper and lower transverse and lengthwise frame members 28a-c, 34a, b and 36a, b are coupled together in a releasable fashion. The assembly of these components is releasable such that the apparatus may be easily assembled and disassembled and the components are easily stored and shipped. It will be appreciated that the disassembly process is the reverse of the assembly process described herein. As further shown in FIG. 3E, the vehicle support members 40a-f are releasably coupled between respective upper transverse frame members 28a-c by simply engaging respective slotted ends 74 of each vehicle support member 40a-f with aligned recesses 78 along one of the edges of the upwardly opening U-shaped transverse frame members 28a-c. The vehicle support members 40a-f are made from steel plates. As shown in FIG. 3F, these vehicle support members 40a-f are registered in place and lay in spaced apart locations as shown between the three spaced apart upper transverse frame members 28a-c.

As shown in FIGS. 3F and 3G, a total of eight steel vehicle support panels 44a-h are then placed on top of the vehicle support members 40a-f. The two support panels 44a, b and 44c, d on each of the outer edges of the apparatus 10 comprise tread deck panels as illustrated on the right hand side of FIG. 3G. Each tread deck panel 44a-d is supported along one lengthwise edge by a respective vehicle support member 40a, b and 40c, d and along the opposite lengthwise edge by an upper lengthwise frame member 30a, b and 32a, b. In this manner, a vehicle 14 (FIG. 1) may be driven onto the platform 10 with its tires rolling on top of the respective tread deck panels 44a-d, and the full weight of the vehicle 14 is supported by the tread deck panels 44a-d and the underlying vehicle support members 40a-d and upper lengthwise frame members 30a, b and 32a, b. This load is then transferred to the ground via the other support components, including the transverse frame members 26a-c, 28a-c and the vertical posts 20a-c, 22a-c. The inner panels 44e-h need not support vehicle weight but instead may simply fill in the space between the tread deck panels 44a-d.

FIG. 3H illustrates the releasable coupling of graphics panels 16 to the vertical support posts 20a-c, 22a-c. Because the vertical support posts 20a-c, 22a-c are formed from carbon steel, magnetic strips 80 may be used between the graphics panels 16 and the vertical support posts 20a-c, 22a-c for purposes of the releasable coupling. For example, the edges of the graphics panel 16 may include magnetic strips 80 fastened thereto, and therefore the graphics panels 16 may be quickly applied and removed, as needed. It will be appreciated that the graphics panels 16 may be coupled to any one or more of the steel vertical posts 20a-c, 22a-c, the steel transverse frame members 26a-c, 28a-c, the steel lengthwise frame members 30a-b, 32a-b, 34a-b, 36a-b, or any other portion of the platform 10 as desired. As further shown in FIGS. 2 and 3F, a plurality of lighting units 120 are releasably coupled to the platform 10 by brackets 122 that extend over the lengthwise frame members 34a, 34b, 36a, 36b. The lighting units may be of any desired design and may be used to illuminate the vehicle 14 and/or the graphics panels 16. It will be appreciated that the lighting units 120 may be coupled to any one or more of the steel vertical posts 20a-c, 22a-c, the steel transverse frame members 26a-c, 28a-c, the steel lengthwise frame members 30a-b, 32a-b, 34a-b, 36a-b, or any other portion of the platform 10 as desired.

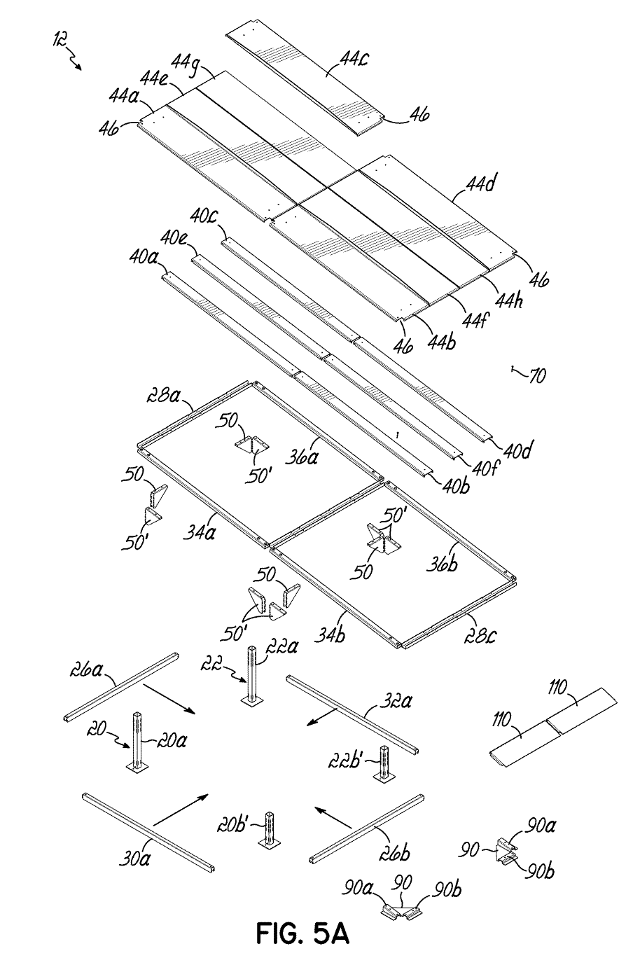

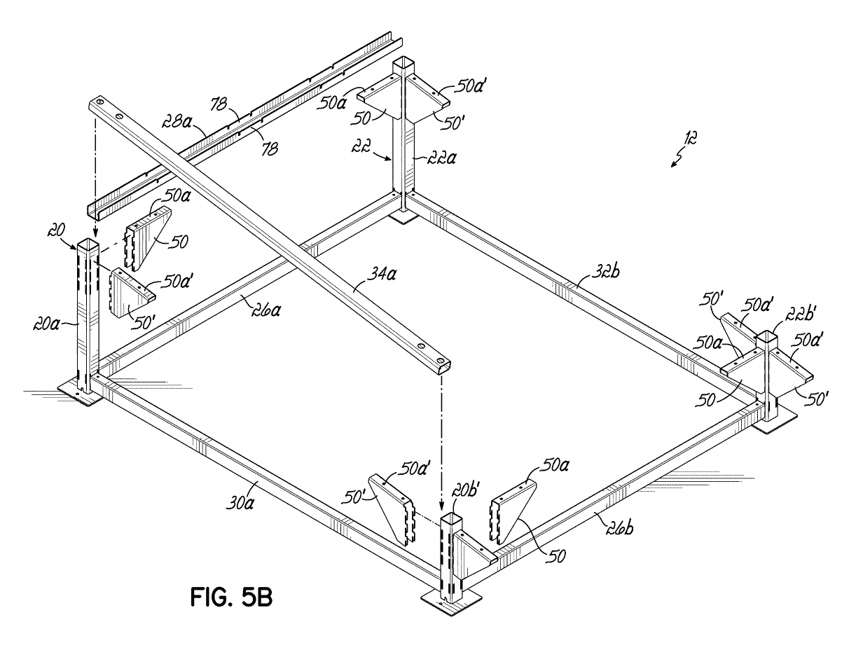

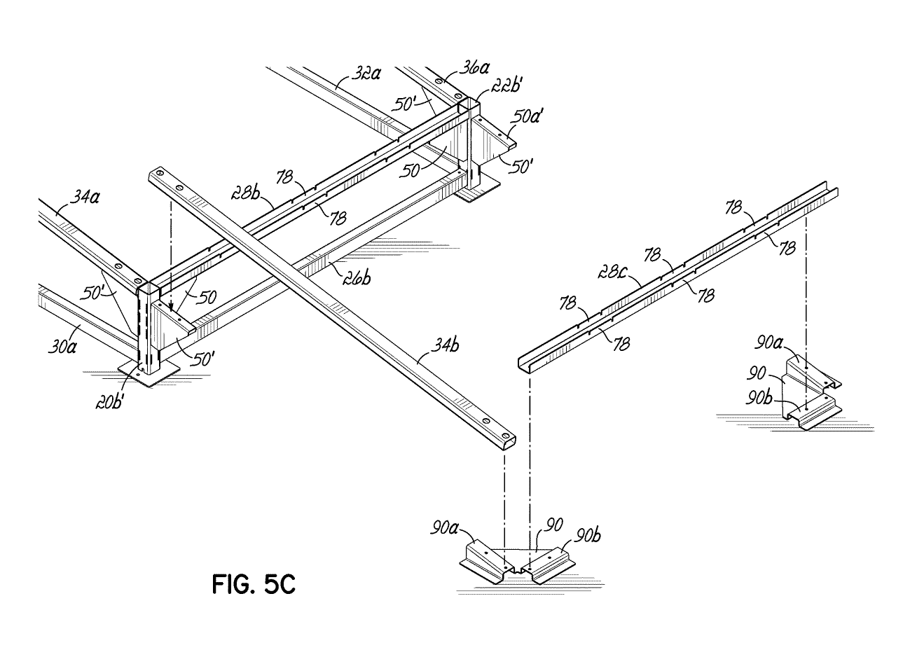

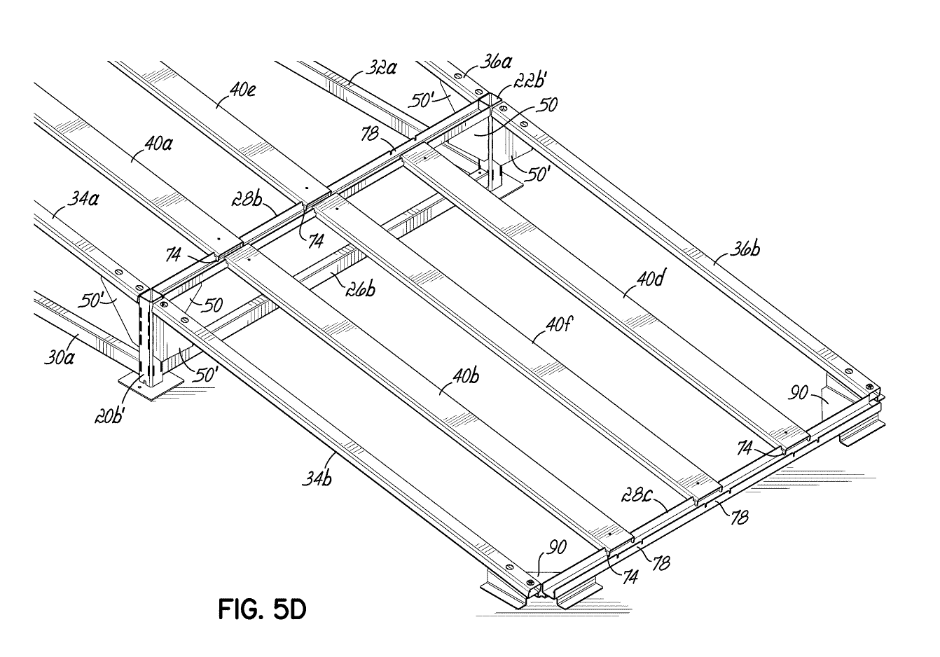

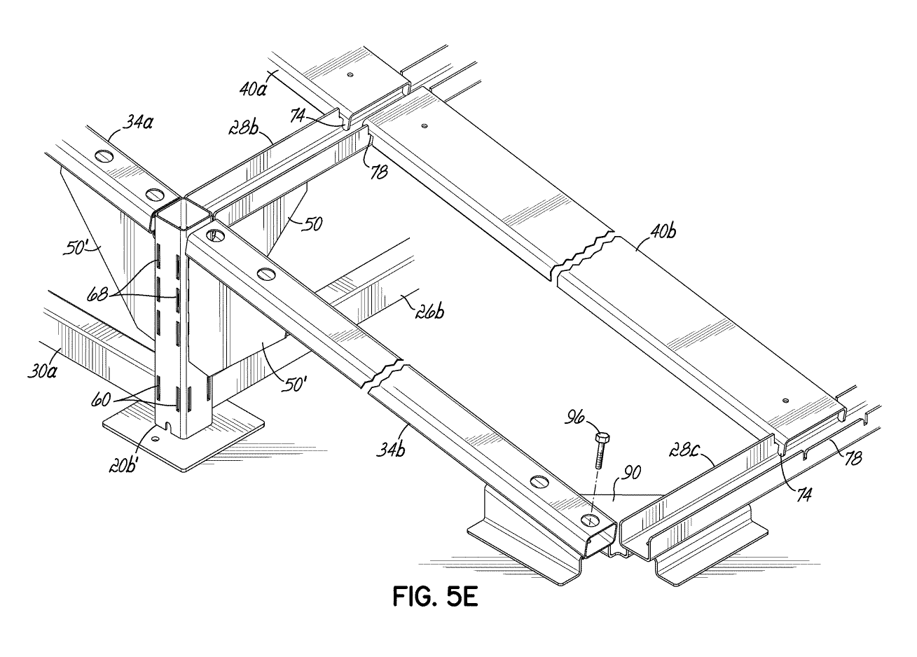

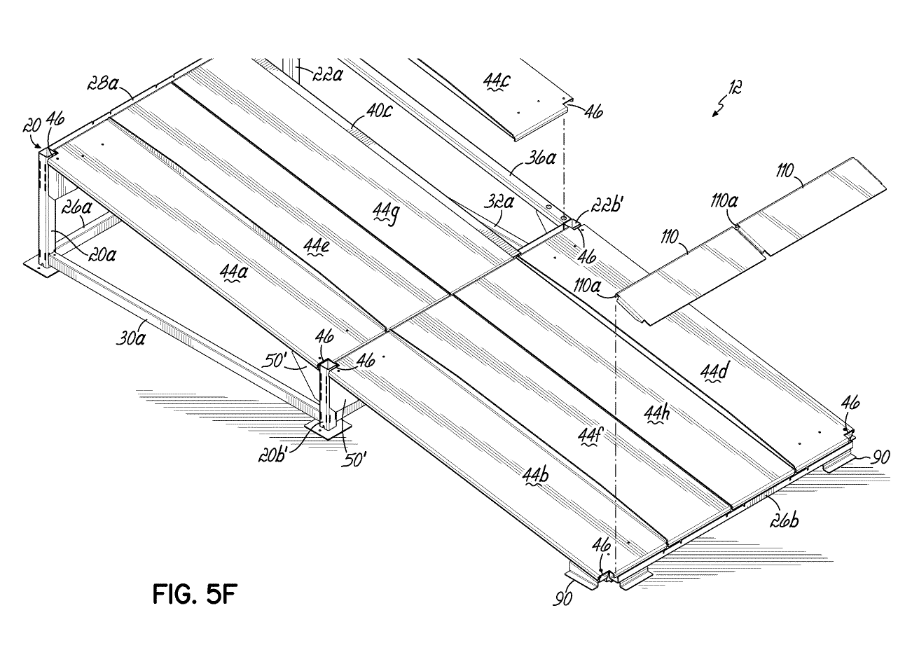

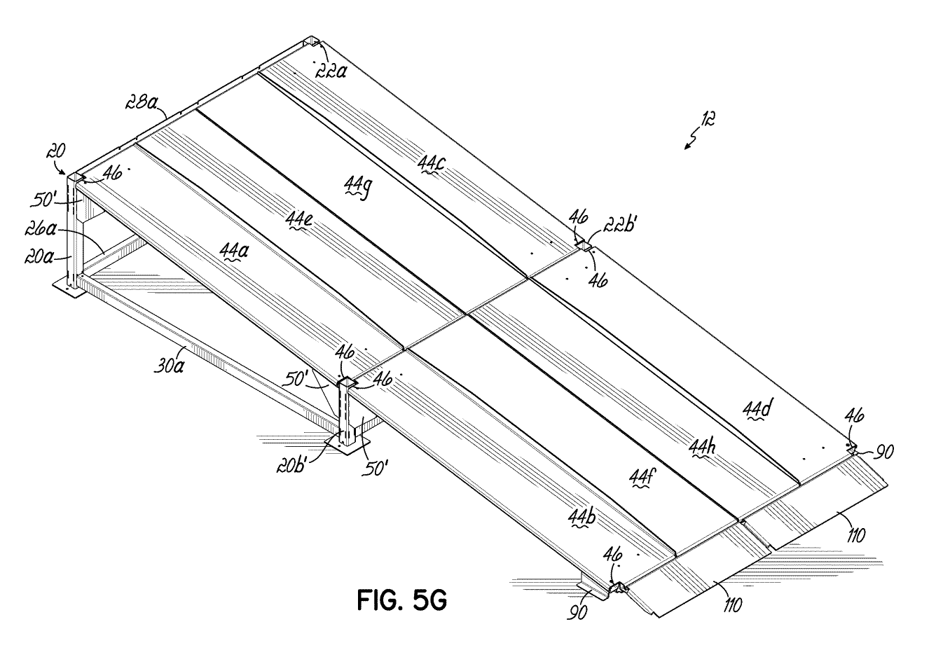

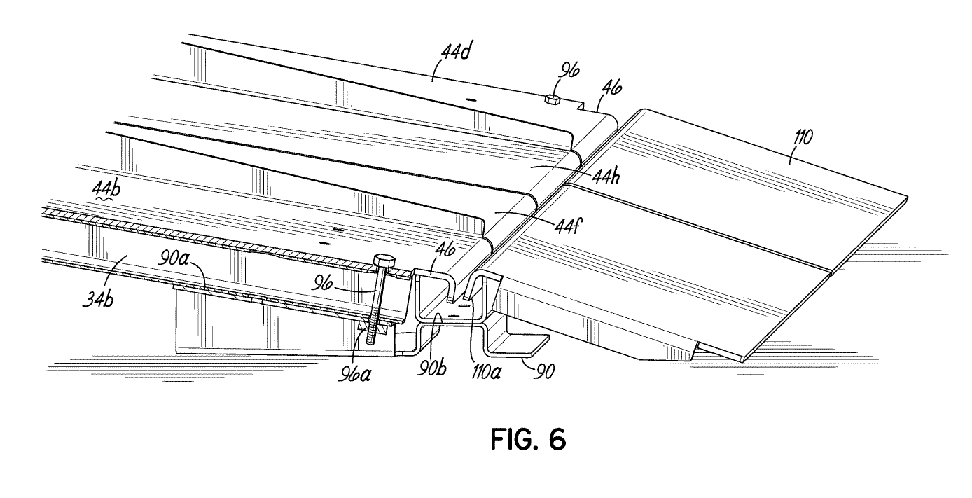

FIGS. 5A-5G and FIG. 6 illustrate another embodiment of the apparatus in the form of a vehicle support ramp 12. This ramp 12 uses many components identical to those shown and described above for the platform 10. This increases the modularity, efficiency of manufacturing, shipping and storage capabilities of the apparatus. For example, with a few additional components for the inclined ramp 12 a user may construct either the platform 10 or the ramp 12 depending on their needs and intended use requirements. Components of the ramp 12 that are identical to those of the platform 10 will be referenced with numbers in FIGS. 5A-5G and 6 that are identical to those used in the first embodiment as previously described above. Therefore, significant additional description of these elements and their assembly is not necessary. Structure or components with new reference numbers in FIGS. 5A-5G and 6 are unique to the ramp 12 of this second embodiment and therefore will be described in more detail. Structure in FIGS. 5A-5G and 6 having like numerals to the first embodiment but with prime marks (′) have certain structural and functional differences that will be described below. The corner brackets 50, for example, which support the upper transverse frame members 28a-c, are identical to the corner brackets 50 used in the first embodiment. However, the upper surfaces 50a′ of the corner brackets 50′ that support the upper lengthwise frame members 34a, b and 36a, b of the ramp 12 are appropriately angled either upwardly or downwardly (with respect to their vertical side) to correspond with the slope or incline of the upper lengthwise frame members 34a, b and 36a, b. The overall slope or incline of the ramp 12 is created by the use of vertical posts that have different heights. For example, the vertical posts 20a, 22a at one end of the ramp 12 may be approximately 32 inches high, while the vertical posts 20b′, 22b′ at the center of the ramp 12 may be approximately 18 inches high. The opposite end of the ramp 12 is close to ground height and is supported by a pair of base brackets 90. An entry incline plate structure 92 is provided at the lower end of the ramp 12 for allowing a vehicle 14 (FIG. 1) to be driven or rolled upwardly onto the ramp 12 and then off the ramp 12.

Turning to FIGS. 5B and 5C, the ramp 12 is constructed in a very similar manner as described above with regard to the first embodiment including the securement of transverse frame members 26a-b, 28a-b and lengthwise frame members 30a-b, 34a-b coupled to the vertical support posts 20a, 20b′, 22a, 22b and the securement of the corner support brackets 50, 50′ to the vertical support posts 20a, 20b′, 22a, 22b. The upper transverse and upper lengthwise frame members 26a-b, 28a-b, 30a-b, 34a-b are secured to the corner support brackets 50, 50′ as previously described. However, in this embodiment it will be appreciated that the upper lengthwise frame members 30a-b, 34a-b will be sloped or angled downwardly from the taller posts 20a, 22a to the shorter posts 20b′, 22b′ and will be supported on the correspondingly sloped or angled upper surfaces 50a′ of the corner brackets 50′. In this embodiment, the slope is approximately nine (9) degrees, however, it will be appreciated that other angles of inclination may be used instead. The upper lengthwise frame members 34b, 36b used in the lower section of the ramp 12 extend from the corner support brackets 50′ to a sloped upper surface 90a of the respective base brackets 90. Again, the slope or angle of the upper surface of each corner support bracket 50′ and the upper surface 90a of each base bracket 90 is approximately nine (9) degrees in this example. The assembly process of the lower ramp section may be understood by reviewing FIGS. 5C and 5D, with FIG. 5D illustrating the addition of the vehicle support members 40a-f between the transverse frame members 28a-c, generally as previously described. It will be appreciated, however, that there is only a single transverse frame member 28c at the lower end of the ramp 12 and, therefore, in this embodiment the lengthwise frame members 34b, 36b and the vehicle support members 40b, d, f respectively extend from the vertical posts 20b′, 22b′ and the upper transverse frame member 26b to the transverse frame member 28c at the lower end of the ramp 12. There is also only a single lower lengthwise frame member 30a, 32a on each side of the ramp 12. FIG. 5E shows a close-up view of the corner bracket 50′, intermediate post 20b′, lengthwise frame member 34b, and vehicle support member 40b and illustrates that the lengthwise frame member 34b is bolted to the base bracket 90, and the transverse frame member 28c is also bolted to an upper surface 90b (FIG. 5C) the base bracket 90 in a manner similar to the previously described construction and assembly of the platform 10 utilizing the corner support brackets 50. In particular, the base brackets 90 will include an integral threaded fastener, such as a nut 36a (FIG. 6) that is welded to the underside of the base bracket 90 such that bolts 96 may be threaded respectively through the transverse and lengthwise frame members 34b, 36b, 28c into the integral nut and tightened to secure the frame members 34b, 36b, 28c to the base brackets 90. As with the transverse corner bracket surfaces 50a, upper transverse surfaces 90b of the base brackets are oriented 90 degrees relative to vertical.

FIG. 5F shows completion of the assembly process by laying the vehicle support members 40a-f between the transverse frame members 28a-c, and laying the vehicle support panels 44a-h on top of the lengthwise frame members 34a, 34b, 36a, 36b and vehicle support members 40a-d generally in the same manner as previously described with respect to platform 10. At the lower end of the ramp 12, however, since there is no vertical support post for registering in the cut-outs 46 as with the platform 10, a fastener 96 is connected between the tread decks 44b, d and the base brackets 90 using a nut 96a welded to the bracket 90, as shown in FIG. 6. To speed assembly and disassembly, all of the threaded nuts used in the apparatus 10, 12 are preferably welded to one of the components being joined to another component. Vehicle entry plates 110 are positioned on an incline as best shown in FIGS. 5G and 6 such that a lip 110a extends into the upwardly opening channel of the transverse frame member 28c. It will be understood that although two entry plates 110 are shown in FIG. 5G, a single longer entry plate may be used instead. It will be appreciated that the ramp 12 may include the graphics panels 16 and/or the lighting units 120 (not shown in the second embodiment), as previously described.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

What is claimed is:

1. A vehicle support and display apparatus, comprising:
a first plurality of vertical support posts;
a second plurality of vertical support posts spaced from the first plurality of vertical support posts;
lower transverse frame members releasably coupled to respective lower portions of the first and second pluralities of vertical support posts;
upper transverse frame members releasably coupled to respective upper portions of the first and second pluralities of vertical support posts;
lower lengthwise frame members releasably coupled to respective lower portions of the first and second pluralities of vertical support posts;
upper lengthwise frame members releasably coupled to respective upper portions of the first and second pluralities of vertical support posts, wherein the lower and upper transverse frame members extend in a transverse direction relative to the lower and upper lengthwise frame members; and,
vehicle support members releasably coupled between respective ones of the upper transverse frame members for supporting the weight of the vehicle.

2. The vehicle support and display apparatus of claim 1, further comprising:
corner support brackets coupled between the respective first and second pluralities of vertical support posts and the upper transverse frame members, and between the respective first and second pluralities of vertical support posts and the upper lengthwise frame members.

3. The vehicle support and display apparatus of claim 2, wherein the corner support brackets are releasably coupled to the respective first and second pluralities of vertical support posts, the upper transverse frame members and the upper lengthwise frame members.

4. The vehicle support and display apparatus of claim 1, further comprising:
vehicle support panels placed on top of the vehicle support members for spreading vehicle load when a vehicle is placed on the vehicle support panels.

5. The vehicle support and display apparatus of claim 4, wherein the vehicle support panels further comprise first and second tread deck panels, and the vehicle support members further comprise a first vehicle support member spaced from and parallel to a first one of the upper lengthwise frame members and a second vehicle support member spaced from and parallel to a second one of the upper lengthwise frame members, the first tread deck panel being supported on the first vehicle support member and the first one of the upper lengthwise frame members and the second tread deck panel being supported on the second vehicle support member and the second one of the upper lengthwise frame members.

6. The vehicle support and display apparatus of claim 1, wherein the vehicle support members are oriented horizontally and form a vehicle platform.

7. The vehicle support and display apparatus of claim 1, wherein the vehicle support members are oriented at an incline and form a vehicle ramp.

8. The vehicle support and display apparatus of claim 1, further comprising:
a graphics panel releasably coupled to at least one of the upper lengthwise frame members, upper transverse frame members lower lengthwise frame members, lower transverse frame members, or vertical support posts.

9. The vehicle support and display apparatus of claim 8, wherein the graphics panel is magnetically coupled to at least one of the upper lengthwise frame members, upper transverse frame members, lower lengthwise frame members, lower transverse frame members, or vertical support posts.

10. The vehicle support and display apparatus of claim 1, further comprising:
a lighting unit coupled to at least one of the upper lengthwise frame members, upper transverse frame members, lower lengthwise frame members, lower transverse frame members, or vertical support posts.

11. A method of assembling a vehicle support and display apparatus, comprising:
placing a first plurality of vertical support posts in spaced apart relation;
placing a second plurality of vertical support posts spaced from the first plurality of vertical support posts;
releasably coupling lower transverse frame members to respective lower portions of the first and second pluralities of vertical support posts;
releasably coupling upper transverse frame members to respective upper portions of the first and second pluralities of vertical support posts;
releasably coupling lower lengthwise frame members to respective lower portions of the first and second pluralities of vertical support posts;
releasably coupling upper lengthwise frame members to respective upper portions of the first and second pluralities of vertical support posts, wherein the lower and upper transverse frame members extend in a transverse direction relative to the lower and upper lengthwise frame members; and,
releasably coupling vehicle support members between respective ones of the upper transverse frame members for supporting the weight of the vehicle.

12. The method of claim 11, further comprising:
coupling corner support brackets between the respective first and second pluralities of vertical support posts and the upper transverse frame members, and between the respective first and second pluralities of vertical support posts and the upper lengthwise frame members.

13. The method of claim 12, further comprising:
releasably coupling the corner support brackets to the respective first and second pluralities of vertical support posts, the upper transverse frame members and the upper lengthwise frame members.

14. The method of claim 11, further comprising:
placing vehicle support panels on top of the vehicle support members for spreading vehicle load when a vehicle is placed on the vehicle support panels.

15. The method of claim 14, wherein the vehicle support panels further comprise first and second tread deck panels, and the vehicle support members further comprise a first vehicle support member spaced from and parallel to a first one of the upper lengthwise frame members and a second vehicle support member spaced from and parallel to a second one of the upper lengthwise frame members, and the method further comprises:
supporting the first tread deck panel on the first vehicle support member and the first one of the upper lengthwise frame members; and
supporting the second tread deck panel on the second vehicle support member and the second one of the upper lengthwise frame members.

16. The method of claim 11, further comprising:
orienting the vehicle support members horizontally to form a vehicle platform.

17. The method of claim 11, further comprising:
orienting the vehicle support members at an incline to form a vehicle ramp.

18. The method of claim 11, further comprising:
releasably coupling a graphics panel to at least one of the upper lengthwise frame members, upper transverse frame members, lower lengthwise frame members, lower transverse frame members, or vertical support posts.

19. The method of claim 18, further comprising:
magnetically coupling the graphics panel to at least one of the upper lengthwise frame members, upper transverse frame members, lower lengthwise frame members, lower transverse frame members, or vertical support posts.

20. The method of claim 11, further comprising:
coupling a lighting unit to at least one of the upper lengthwise frame members, upper transverse frame members, lower lengthwise frame members, lower transverse frame members, or vertical support posts.
